(19) United States
(12) Patent Application Publication
(10) Pub. No.: US 2009/0245972 A1
(43) Pub. Date: Oct. 1, 2009

(54) FASTENER WITH MULTIPLE THREADED SECTIONS

(75) Inventors: CHING-GUEI LIN, KAOHSIUNG COUNTY (TW); MAU-CHANG WU, KAOHSIUNG COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHANNG CHIN INDUSTRY CORP., KAOHSIUNG COUNTY (TW)

(21) Appl. No.: 12/060,454

(22) Filed: Apr. 1, 2008

(51) Int. Cl. F16B 35/04

(52) U.S. Cl. 411/411

(57) ABSTRACT

The present invention pertains to a triangular shank with multiple threaded sections essentially including a head, a shank and a drilling portion. Wherein the shank has two opposite threaded sections formed in triangular and a third threaded section spiraling on the drilling portion. The third threaded section with a planar flank assists in enlarging the drilling track and providing guidance for those two threaded sections to easily enter into the object so as to efficiently extrude the debris out of the object and retain remaining debris for a better fastening effect. Further the triangular configuration results in the less contact between the screw and the object in time of screwing, thus reducing the frictional resistance and obtaining high screwing speed.

### BACKGROUND OF THE INVENTION

1. Field of the Invention

The present invention relates to a fastener, in particular to a screw with multiple threaded sections.

2. Description of the Related Art

A conventional screw 1 shown in FIG. 1 generally comprises a head 11, a cylindrical shank 12 extending therefrom, and two opposite threaded sections with separate circular threads namely a first threaded section 13 and a second threaded section 14 spiraling round the shank 12 and separated by a thread-free section 15; wherein, a drilling portion 121 is formed at the end of the shank 12 and has a pointed tip 122 formed at its free end, where the first threaded section 13 can be helically disposed.

Still, in operation, the drilling portion 121 has a preliminary drilling into the object 2 for proceeding the subsequence cutting by the first threaded section 13. However, the circular threads and the shank 12 are unable to accommodate as much cutting debris and smoothly extrude the debris out of the surface of the object 2, therefore causing a larger inserting torque as well as a slower screwing speed while drilling the first threaded section 13 into the object 2. Further, the debris generated from the region of the first threaded section 13 is moved back down via the assistance of the second opposite threaded section 14; the second threaded section 14 with circular threads, however, does not provide enough spaces or void for accommodating debris and retains accumulating it within the objects without guiding it out, hence the conventional screw 1 would result not only in increasing the screwing resistance but also rendering the object 2 to be subjected to the crack under the incessant accumulation therein.

### SUMMARY OF THE INVENTION

It is an object of the present invention to provide a screw with multiple threaded sections, which facilitates to increase the screwing speed, efficiently guide debris out and obtain a better screwing effect.

The present invention in conformity with the screw with multiple threaded sections essentially comprises a head, a triangular shank, and a drilling portion; wherein, the shank includes two opposite threaded sections with first and second threads, each of which performs in a triangular contour and has a sharp edge defined thereon; further, a third threaded section disposed on the drilling portion and has a planar flank formed to converge toward the sharp edge of the adjacent first thread. Therefore, the triangular threads and shank reduce the contact of the screw and the object while screwing for further reducing the frictional resistance and obtaining high screwing speed. The two opposite threaded sections can also assist the cutting debris in being efficiently extruded out of the object and provide a larger void to accommodate the remaining debris, thus preventing the crack of the object and permitting the screw to be firmly embedded into the object.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a schematic view showing a conventional screw;

FIG. 2 is a perspective view showing a first preferred embodiment of the present invention;

FIG. 3 is a schematic view showing the first embodiment in use;

FIG. 4 is a cross sectional view showing the first threaded section of the first preferred embodiment;

FIG. 5 is a cross sectional view showing a portion “A” of FIG. 3;

FIG. 6 is a cross sectional view showing a portion “B” of FIG. 3; and

FIG. 7 is a perspective view showing a second preferred embodiment.

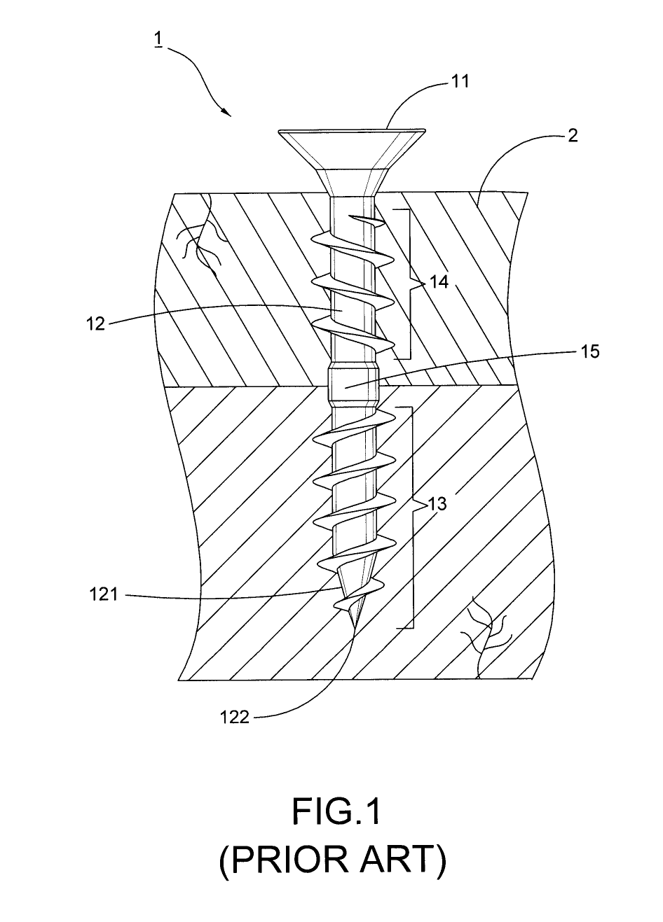

### DETAILED DESCRIPTION OF THE PREFERRED EMBODIMENTS

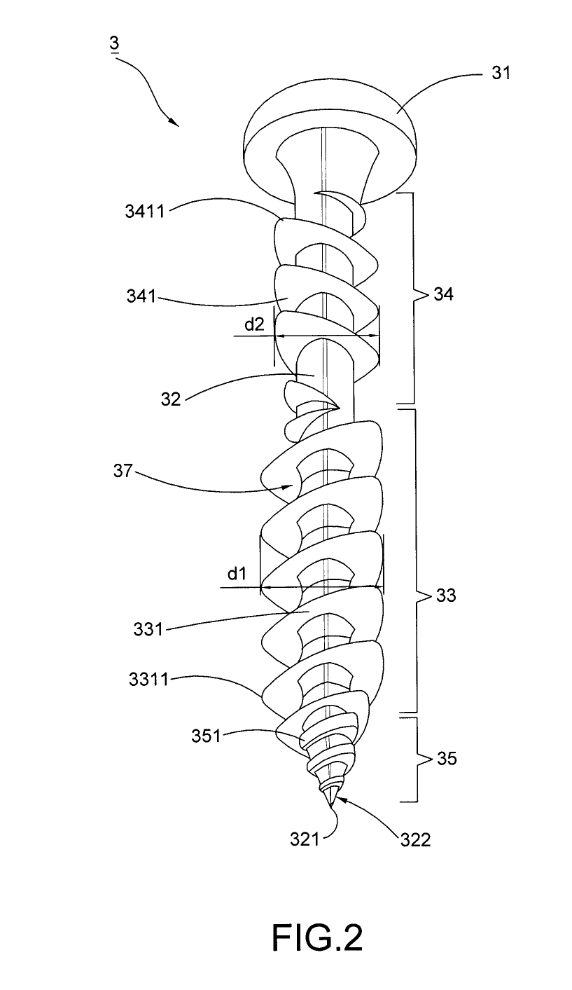

Referring to FIG. 2, a screw 3 of the first preferred embodiment comprises a screw shank 32, a screw head 31 formed on one end of the shank 32, a drilling portion 322 formed on the other end thereof, a first threaded section 33 spiraling round the screw shank 32, a third threaded section 35 disposed on the drilling portion 322 and a second threaded section 34 located between the first threaded section 33 and the head 31; wherein, the shank 32 is formed in a triangular contour, and the drilling portion 322 has a pointed tip 321 at its distal end. Further, the first threaded section 33 has a plurality of first threads 331 which are of triangular contours as well; each first thread 331 has a sharp edge 3311 formed on a periphery thereof.

Still further, the third threaded section 35 has a planar flank 351 formed thereon, and the planar flank 351 converges toward the sharp edge 3311 of the adjacent first thread 331 and contacts therewith. Additionally, the second threaded section 34 comprises a plurality of second threads 341 thereon which are of triangular contours; each of the second threads 341 also forms a sharp edge 3411 formed on the periphery thereof. The first threaded section 33 and the second threaded section 34 have their threads 331, 341 present in opposite spirals, and properly the first threaded section 33 has a major diameter “d1” larger than a major diameter “d2” of the second threaded section 34.

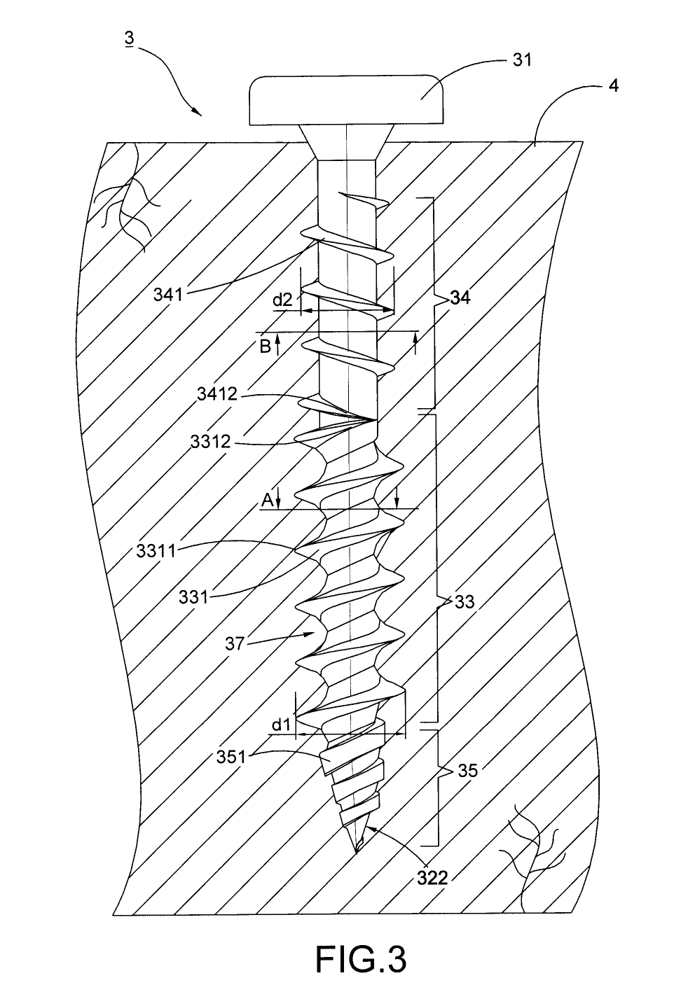

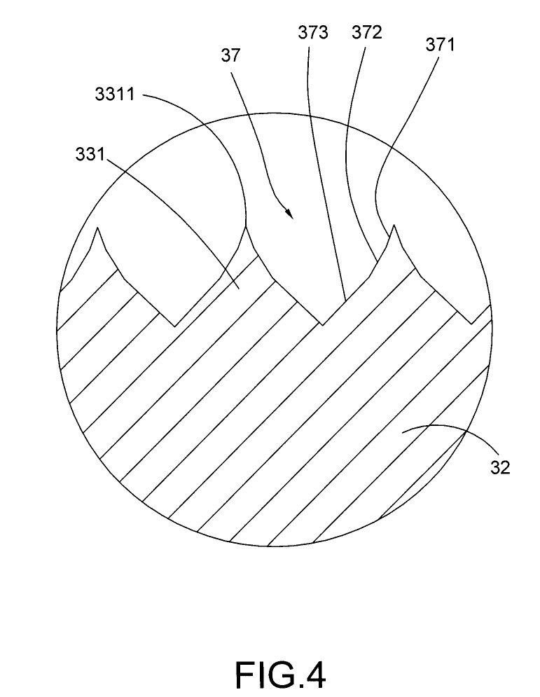

Referring to FIG. 3, the first threaded section 33 particularly has a first thread end 3312 attached to a second thread end 3412 of the second threaded section 34 and each of the first threads 331 has symmetrical inflections formed on both flanks thereof and respectively extended from the sharp edge 3311, to be precisely illustrated in FIG. 4, each of the flanks comprises a leading surface 371, a loading surface 372 attached to the leading surface 371, and thence a root surface 373 connecting to the loading surface 372; the root surface 373 contacts with another the root surface 373 so that a concave portion 37 is present between any two adjacent first threads 331. Furthermore, lengths of the above surfaces can be at any appropriate ratio, and preferably the ratio of the lengths of the leading surface 371 to the loading surface 372 and to the root surface 373 is adopted at 1:2:5 in the preferred embodiments.

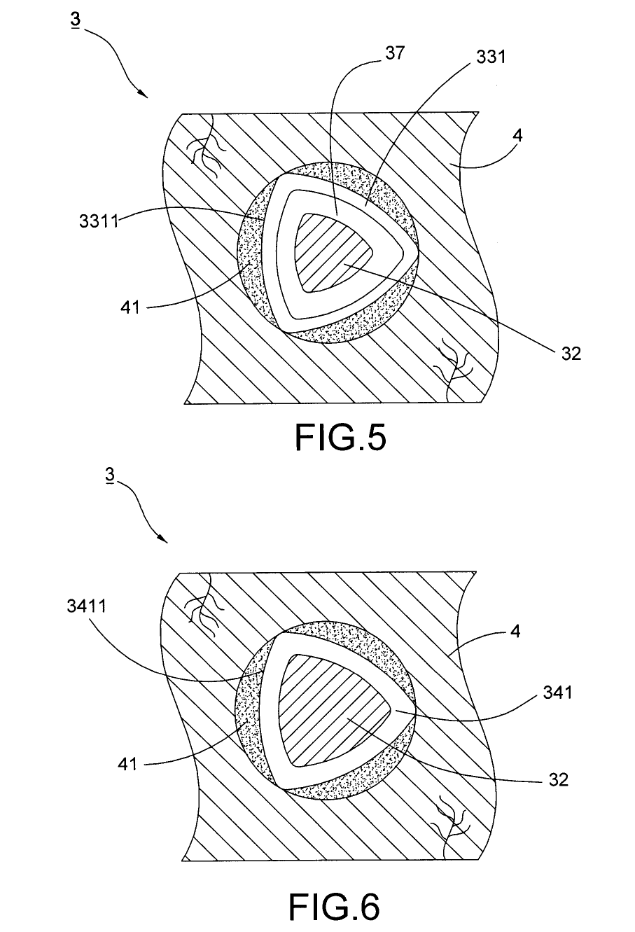

Referring to FIG. 3, in operation, initially impart a force upon the screw head 31 and rotate the screw 3 to be drilled into the object 4 via the drilling portion 322. By means of the third threaded section 35 with the planar flank 351, the drilling track is enlarged so that the sharp edges 3311 of the first threads 331 can follow the track to easily enter into the object 4 and simultaneously chip the fibers of the object 4 into debris. In this manner, a void 41, as shown in FIG. 5, generated between the track and sharp edge 3311 of the triangular first thread 331 and the configuration of the concave portion 37 permit part of debris to transfer therebetween. Consequently, the concave portion 37 assists in not only receiving the debris therein but also leading the movement of the debris, therefore increasing the screwing speed via reducing the inserting torque and the frictional resistance.

Further, the debris can also be smoothly extruded out of the object 4 through the assistance of the second threaded section with smaller diameter “d2” and the attachment of the first threaded end 3312 and the second thread end 3412 so as to avoid the crack of the object 4 under the incessant accumulation. As subsequently shown in FIG. 6, the second threads 341 keep running into the object 4 after the first threads 331 are entirely drilled in and render the non-excluded debris moving back to the void 41 so that allowing the screw 3 to be firmly fastened into the object 4. Thus, the screw 3 would not swing by the interaction of the two opposite threaded section 33, 34 after embedding it into the object 4 even though a percussive force is simultaneously applied to the screw 3.

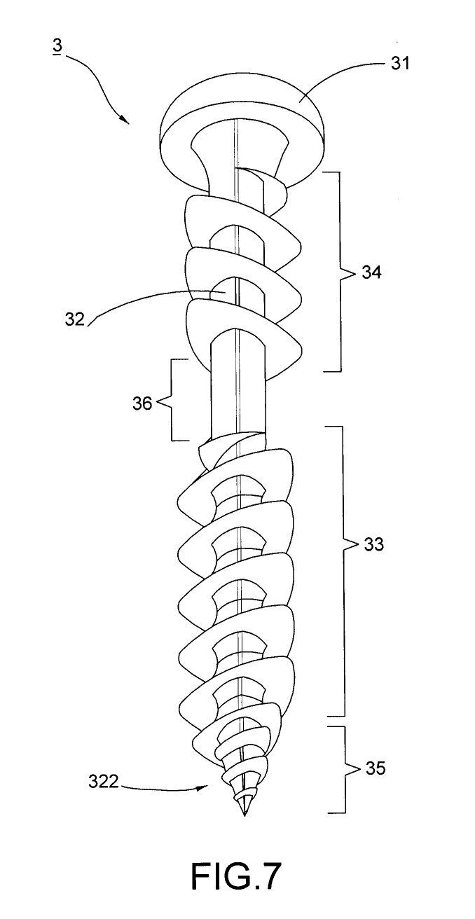

Referring to FIG. 7, the screw 3 of the second preferred embodiment still has the same concatenation of elements, namely a head 31, a shank 32, two opposite threaded sections 33, 34, a third threaded section 35, and a drilling portion 322. Differentially, a non-threaded section 36 is disposed between the first threaded section 33 and the second threaded section 34, whereby the non-threaded section 36 bridges the contact of the composite objects 4 (not shown) and enhances the fastening effect.

To sum up, the present invention takes advantage of a triangular shank with two opposite threaded sections and a third threaded section spiraling on the drilling portion. Therefore, the third threaded section provides guidance for the first threaded section to easily enter into the object; further, the triangular design reduces the contact of the screw and the object for reducing the resistance and obtaining high screwing speed and forms the void for guiding the debris out and receiving remaining debris, thus preventing the crack of the object and permitting a better fastening effect.

While we have shown and described the embodiment in accordance with the present invention, it should be clear to those skilled in the art that further embodiments may be made without departing from the scope of the present invention.

I claim:

1. A screw with multiple threaded sections comprising:
a screw head;
a triangular screw shank outwardly extending from said screw head and forming a drilling portion to be disposed on an end thereof, opposite to said screw head; said drilling portion providing with a pointed tip at a distal end thereof;
a first threaded section spiraling round said screw shank and having a plurality of first threads thereon; said first threads being of a triangular shape and each providing with a sharp edge formed on a periphery thereof;
a third threaded section disposed around said drilling portion and having a planar flank formed thereon, said planar flank converging toward said sharp edge of said adjacent first thread and contacting therewith; and
a second threaded section located between said first threaded section and said screw head and having a plurality of second threads thereon; said second threads being of a triangular shape and each providing with a sharp edge formed on a periphery thereof; said first threads and said second threads spiraling in opposite directions.

2. The screw as claimed in claim 1, wherein said first threaded section includes a first thread end attached to a second thread end of said second threaded section.

3. The screw as claimed in claim 1, wherein a non-threaded section is disposed between said first threaded section and said second threaded section.

4. The screw as claimed in claim 1, wherein each of said first threads provides with symmetrical inflections formed on both flanks thereof and respectively extended from said sharp edge; each said flank comprises a leading surface, a loading surface attached to said leading surface, and a root surface connecting to said loading surface; said root surface contacts with another said root surface so that a concave portion is present between said two adjacent first threads; the ratio of lengths of said leading surface to said loading surface and to said root surface is preferably at 1:2:5.

5. The screw as claimed in claim 1, wherein said first threaded section has a major diameter larger than a major diameter of said second threaded section.
